(19) United States
(12) Patent Application Publication
(10) Pub. No.: US 2004/0181415 A1
(43) Pub. Date: Sep. 16, 2004

(54) Speech activated telephone device for connection to existing landline phone

(75) Inventors: Thomas S. Krol, Philadelphia, PA (US); Joseph R. Petrella, JR., East Amwell, NJ (US)

Correspondence Address: Kenneth P. Glynn, Esq., Glynn & Associates, P.C., 24 Mine Street, Flemington, NJ, 08822, US

(73) Assignee: IMET CORPORATION

(21) Appl. No.: 10/807,813

(22) Filed: Mar. 24, 2004

Related U.S. Application Data
(63) Continuation-in-part of application No. 09/765,859, filed on Jan. 19, 2001, now abandoned.

(51) Int. Cl. H04M 1/64

(52) U.S. Cl. 704/275

(57) ABSTRACT

The present invention is directed to a speech activated, speech operated, device for connection to an existing landline telephone with a one touch dialing feature, for hands-free automatic dialing. It includes a main housing, with a telephone control circuit to induce dialing of a telephone number, an encoder circuit connected to the telephone control circuit and a speech recognition module. The speech recognition module includes a processor for driving the other functions therein. The speech recognition module is connected to the encoder circuit and to a microphone and speaker for receiving speech input and transmitting audible and visible output, respectively. There is a power source connection connected to the telephone control circuit, the encoder circuit and the speech recognition module.

### REFERENCE TO RELATED APPLICATION

This application is a continuation-in-part of copending U.S. application Ser. No. 09/765,859, filed on Jan. 19, 2001, entitled “SPEECH ACTIVATED TELEPHONE DEVICE FOR CONNECTION TO EXISTING TELEPHONE”.

### BACKGROUND OF THE INVENTION

1. Field of the Invention

The present invention relates to voice activated, voice operated telephone devices specifically fitted to existing landline telephones, as well as the combination of both the device and a landline phone. It enables a user, such as someone who is incapacitated or cannot utilize normal hand functions, to both turn on (activate) and to operate the device and phone, in a completely hands free manner. The device will guide a first user through initial training to input key words for future directions that are completely given to the device by a second user. The first user (training input person) and the subsequent, second user may be different persons, or with some initial assistance, the first and second user may be the same person. This invention eliminates the need for complex systems with computers to retrofit existing landline phones.

2. Information Disclosure Statement

The following patents are representative of various types of voice activated telephone dialing systems:

U.S. Pat. No. 4,945,557 describes an automatic dialing apparatus for use in a telephone or facsimile machine which sends out a dial signal to an external network automatically. A detachable telephone number memory, which stores a telephone number together with an area code, is detachably mounted on a telephone unit which includes a memory storing and area code of the district in which the telephone unit is located. The area code of the telephone number data supplied from the telephone number memory is deleted if that area code agrees with the area code stored in the memory of the telephone unit. An automatic dialing apparatus is preferably constructed to carry out dialing automatically responsive to a voice. In the preferred embodiment of such a voice activated dialing apparatus, a telephone number is input through a keyboard and a corresponding identifier, typically the name of a subscriber, is voiced and its voice signal is stored in association with the telephone number.

U.S. Pat. No. 5,007,081 describes a speech activated telephone that is disclosed. The speech activated phone stores a plurality of spoken words, the telephone number and the alphanumeric word associated with the spoken word. The telephone automatically dials the telephone number in response to inputted spoken word, matching the stored spoken word. In addition, the telephone number and alphanumeric text for the matched spoken word is displayed.

U.S. Pat. No. 5,148,471 sets forth a portable radiotelephone with an integral voice recognition circuit which is disclosed. Control of the voice recognition circuit is achieved with a foldable housing element which, in a closed position, covers an external keypad and control buttons. When the foldable housing element is in an open position, the portable radiotelephone is placed in an off-hook condition, the voice recognition circuit is activated, and the acoustic transducers are coupled to the voice recognition circuit. When the foldable element is in a closed position, the portable radiotelephone is placed in an on-hook condition, the voice recognition circuit is deactivated, and the electroacoustic transducers are coupled to the radiotelephone. A rapid closing and opening of the foldable element results in the voice recognition circuit being deactivated while the portable radiotelephone remains in the off-hook condition.

U.S. Pat. No. 5,369,685 describes a voice activated telephone directory and call placement system accessible over a telecommunications network which allows a caller to store a personalized telephone directory, and to retrieve a selected directory listing therefrom by speaking a series of voice entries. In response, the system selectively provides a voice rendition of a destination telephone number associated with the listing and optionally initiates dialing of the number.

U.S. Pat. No. 5,452,340 describes the present invention which relates to a method of interface between a voice activated dialing system and a user. The present invention solves the problems presented by the prior art by providing a user interface which can add a name and corresponding telephone number to a directory during the process of initiating a telephone call. In addition, the present invention provides the user the opportunity to select which element of a directory listing should be changed, using a single integrated review, erase and change functionality accessible while in a directory mode.

U.S. Pat. No. 5,717,738 describes a voice recognition telephone system (10) which allows a user to generate a plurality of directions (76). Each directory has a corresponding entry list containing a plurality of entry names and corresponding phone numbers. The user can add (172) or remove (170) entry names as desired. The user can enter phone numbers (192) for each entry name and modify phone numbers as desired. The user can also place a call (158) through a generated entry name.

U.S. Pat. No. 5,991,364 describes a telephone communications system Advanced Intelligent Network (AIN) platform which provides a voice activated call dialing functionality through speaker independent phoneme speech recognition that have a minimum volume of storage without requiring user template training. Speaker independent phoneme recognition identifies phoneme strings of caller spoken utterances which are then compared to phoneme string representations that previously have been stored in respective caller processing records (CPRs) for those subscribers listed in the ISCP database, or stored in an equivalent peripheral database with which the ISCP can communicate. Each stored phoneme string representation is associated in the CPR with a destination telephone number that may then be extracted to route a call.

Notwithstanding the prior art, the present invention is neither taught nor rendered obvious thereby.

### SUMMARY OF THE INVENTION

The present invention is a speech activated device for attachment to an existing telephone, for hands-free dialing. This may be used in the present invention in any telephone with a preprogrammable one touch dialing feature.

One critical aspect of the present invention device is that it converts the one touch dialing of a conventional telephone to voice activated dialing. It receives and recognizes the voice, converting from audio to analog signals which are sent to the telephone to activate the buttons hands-free. This feature is also the basis for activating not only the one touch dialing feature, but also other button-activated features, such as mute, speakerphone, redial, and any other button-activated phone feature.

Thus, the present invention device includes a main housing, containing:

a telephone control circuit for analog input to a telephone with a one touch dialing feature to induce dialing of a telephone number selected from a preloaded directory;

an encoder circuit connected to the telephone control circuit for sending digital signals thereto and connected to a speech recognition module for receiving signals therefrom and converting digital signals from the module into recognizable digital signals to control the telephone control circuit which selects the button-based functions of the telephone, including the aforesaid one touch dialing; and,

a speech recognition module contained within the main housing which includes a processor for driving the other functions therein. The speech recognition module is connected to the encoder circuit and to a microphone and speaker for receiving speech inputs and transmitting audio outputs.

There is a power source and a power source connection into the main housing, to at least one of the telephone control circuit, the encoder circuit and the speech recognition module for powering the device. In some embodiments, the power source connection is connected to one of the above components and that in turn is connected to one or more of the other components. In the most preferred embodiment, the power source connection is to all three of these components. This power source connection may be directly connected to the above device circuits or may be indirectly connected, e.g. via a voltage regulation circuit.

A telephone connecting means is connected to the telephone control circuit for connection to a telephone.

The power source may be any workable power source, and will in most instances, require current conversion and voltage regulation (e.g. for standard AC residential power). Thus, the present invention will include voltage regulation where necessary. The preferred voltage regulation circuit with voltage regulator will be connected to the telephone control circuit, the encoder circuit and the speech recognition module, as well as at least one external speaker, via the power source connection. The voltage regulation circuit may be included within the main housing or external therefrom, but is preferably included in the main housing.

In other embodiments, the present invention includes the telephone in combination with the aforesaid device.

Also, in some preferred embodiments, the device speech recognition module includes both visible and audible feedback hardware and/or software.

The device may also include at least one battery connected to the power source connection. In some instances, an optional rechargeable backup battery and charger circuit may be included.

The telephone connecting means utilized in the present invention device is preferably a ribbon cable or group of wires which includes connection to the contact points of a plurality of name/telephone number buttons of a conventional telephone's one touch dialing unit, as well as connection to other desired features, such as redial, mute, volume control, speaker phone, etc.

Optionally, the present invention device may further include training instructions for a user. Also, the present invention may include a prompting program to prompt a user to serially input a plurality of names and corresponding phone numbers for future recall by name for automatic dialing of the corresponding number. There may be a training button for initiating the training instructions, or a training recording could be initiated by voice activation, such as by saying TRAIN ME.

### BRIEF DESCRIPTION OF THE DRAWINGS

The present invention should be more fully understood when the specification herein is taken in conjunction with the drawings appended hereto wherein:

FIG. 1 illustrates a block diagram of one arrangement of a present invention device;

FIG. 2 shows a symbolic wiring diagram for critical features of a present invention device with phone; and,

FIG. 3 illustrates a top view of a present invention device and phone and FIG. 4 illustrates a side view thereof.

### DETAILED DESCRIPTION OF THE PRESENT INVENTION

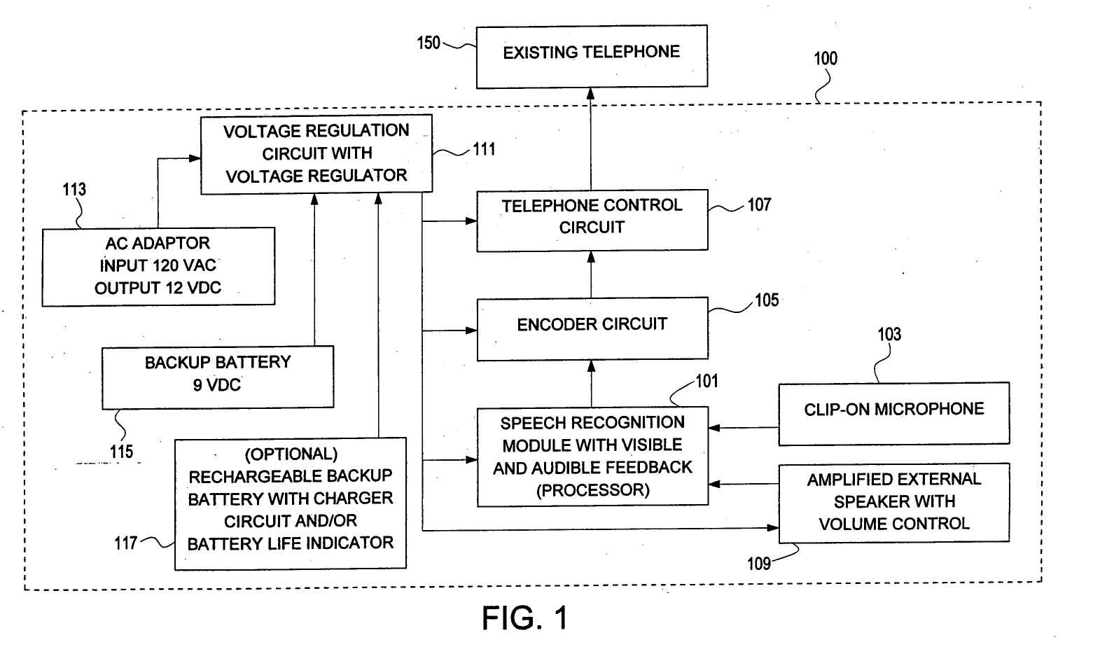

The present invention is directed to a device for attachment to a telephone with a one touch dialing feature, as described above. Details of some preferred embodiments are illustrated in FIG. 1 in block form.

Referring to FIG. 1, there is shown a telephone 150 which is an existing telephone with a preprogrammable one touch dialing feature. In some embodiments, the present invention is a device such as device 100 and, in other embodiments, the present invention is a device and a telephone, such as telephone 150 in combination.

Device 100 includes a speech recognition module 101, which optionally includes both audible and visible feedback, and minimally includes visible feedback.

Speech recognition module 101 is connected to an external microphone 103 and is also connected to external speaker 109. Speaker 109 could be built-in, but is preferably an external speaker with volume control, and preferably, volume control from the speech recognition module. Voltage regulation circuit 111 is connected to AC adaptor 113, providing power to device 100. Voltage regulation circuit 111 is connected to the speech recognition module 101 and the other circuits, as shown.

Speech recognition module 101 may be an off-the-shelf unit, such as “Voice Direct 364”, manufactured by Sensory, Inc. of Sunnyvale, Calif. Such units have sufficient voice recognition capability to easily support a name-based telephone directory of ten to twenty-five or more entries. Such units include a processor with sufficient capabilities to control other necessary functions of the device. The details of the functionality of the present invention will be more clearly understood in relationship to the detailed example set forth below.

Speech recognition module 101 converts incoming audio signals to digital signals which are recognized by encoder circuit 105 for conversion to control signals to the telephone control circuit. Telephone control circuit 107 sends analog signals to the contact points mentioned above, imitating the depression of a button to complete a circuit and initiate a function, such as a hands-free dial up.

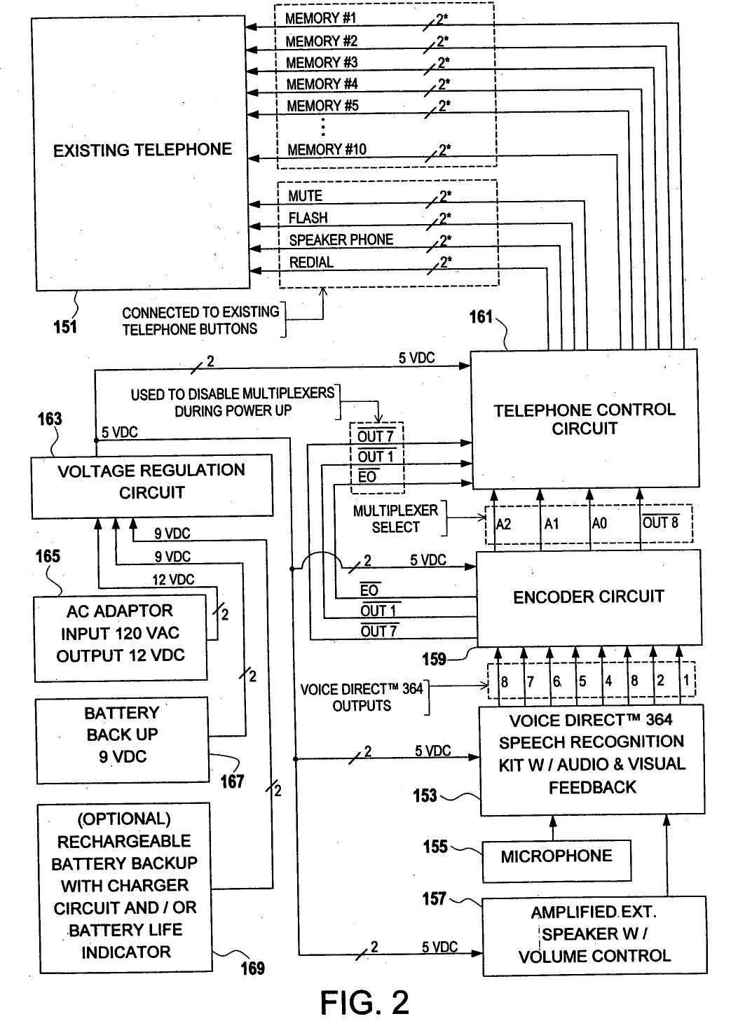

FIG. 2 illustrates a more specific embodiment of the present invention. As with FIG. 1 above, this example shown in block form is representative of preferred embodiments of the invention, and numerous variations, wiring rearrangements and substitutions may be made without exceeding the scope of invention. In FIG. 2, existing telephone 151 is shown, and this would include a one touch dialing feature with a programmable directory. The present invention device includes the speech recognition module 153 as its core component, and in this case, “Voice Direct 364” described above. Module 153 is connected to external microphone 155, such as a clip-on microphone, and to external speaker 157.

Module 153 is connected to encoder circuit 159 via an eight wire ribbon to convert the eight outputs from module 153 into fifteen distinct signals for controlling the telephone push button features for hands-free activation. These fifteen signals are sent to telephone control circuit 161, which contains analog multiplexers and/or relays to simulate the action of pressing the existing telephone buttons manually. It also disables multiplexers during power up.

Telephone control circuit 161 is connected to existing telephone 151 via the connections shown, which connections have the functions designated in the drawing. In the existing telephone one touch dialing feature, phone numbers are stored therein and the inputs from telephone control circuit 161 correspond thereto. Some of the wiring between various components may have plural connections in the interest of economy and efficiency. For example, some of the wires from the telephone control circuit 161 to existing telephone 151 are common among the different buttons on the phone. These common connections need to be brought to the existing telephone once.

Voltage regulation circuit 163 is connected to the other main components, as shown, to provide a 5V DC source to the components. It also has optional AC adaptor 165, with 120V AC to 12V DC conversion, battery backup 167 and charger and rechargeable battery backup 169.

In summary, the embodiment of FIG. 2 operates to provide hands-free dialing and other operations to users who are handicapped or otherwise desire hands-free telephonic operations. It receives, controls and responds to the following voice commands: (a) the dialing of up to ten numbers; (b) speaker phone; (c) mute; (d) redial; (e) flash (call waiting); and audible and visible feedback on word recognition. It will also provide battery backup control and power trouble signaling.

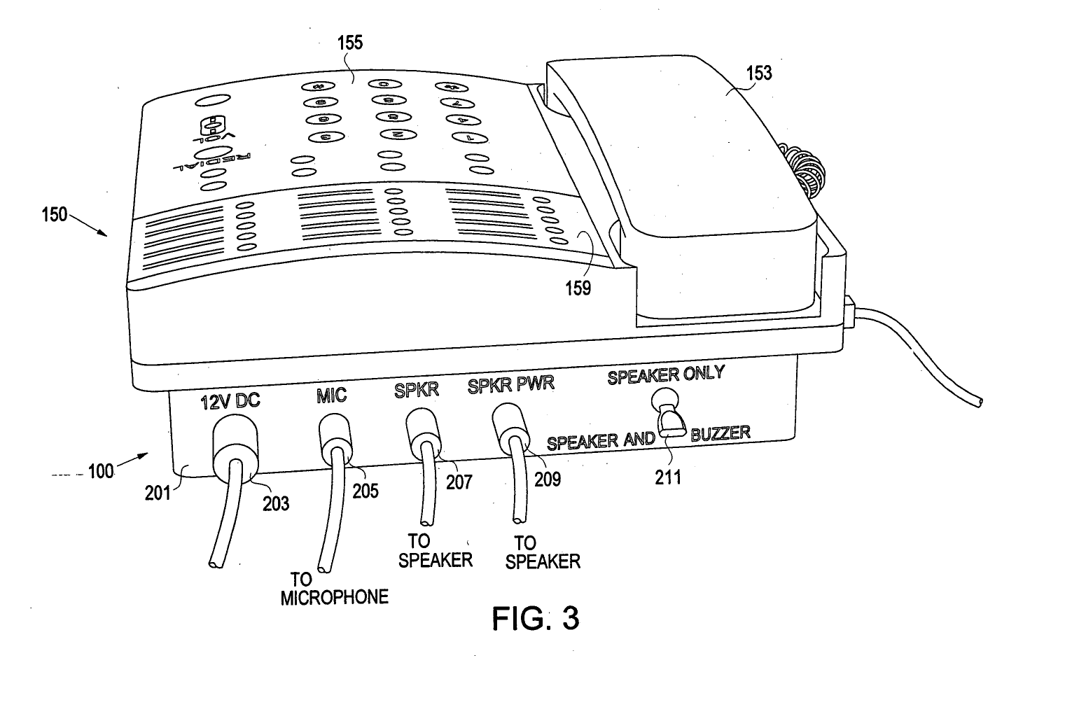

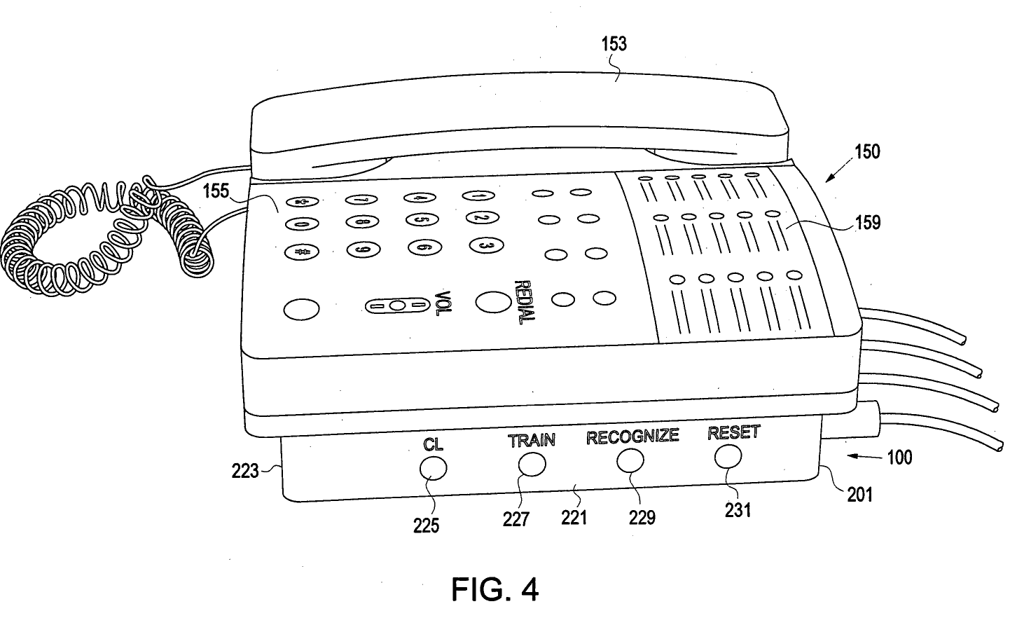

Referring to FIG. 3, there is shown a top view of a telephone 150 with a present invention device 100, and these are also shown in a side, oblique view in FIG. 4. Telephone 150 includes a hand set microphone speaker 153 and a cover 155 with conventional one touch dialing buttons 159.

FIG. 3 shows various connections for device 100: the speech recognition unit 101 of FIG. 1, the encoder circuit of 105 of FIG. 1 and the telephone control circuit 107 of FIG. 1. External connections include a microphone plug 205, a speaker plug 207 and a speaker power connection 209. Also shown on top 201 of device 100 is an optional switch 211 for utilizing a speaker only mode or a speaker plus buzzer mode. A power source connection 203 could be connected to an external transformer plugged into a common household outlet for receiving 120 volts AC and for sending 12 volts DC to the voltage regulation circuit, which sends regulated 5 volts DC to the other circuits within device 100. The voltage regulation circuit could connect to an optional backup battery and/or rechargeable backup battery with charger. These options are shown as blocks 115 and 117 in FIG. 1.

FIG. 4 shows the same device with side 221 facing the viewer, with top 201 to the right and bottom 223 to the left. In this view, device 100 shows a continuous listening “cl” button 225, a “train” button 227, a “recognize” button 229 and a “reset” button 231.

The following is a sample of instructions which may be used in initialization of a speech recognition module of a present invention device:

Quick Start Guide

1. Set the sound to the “SPEAKER ONLY” position (up).

2. Turn power switch on (ON=1, Off=0).

I. Programming:

1. First you will need to teach the unit a word that will prompt it to listen for a command or preset dial word. This word lets the unit know that you want to give a command or preset dial word to operate the phone. Press the CL button. The unit will prompt:

“Say word one”.

You must now say the word that you wish to use as the prompting word.

Prompt Word: ______.

The unit will now prompt:

“Repeat!”

You must now repeat your chosen prompt word.

If the unit accepts the prompt word, it will say:

“Accepted!”

If the word is spoken differently in the two versions, the unit will say:

“Error!”

If this occurs, you will need to start over. The unit may prompt you to repeat the word again, but if the unit is silent, start over.

If you speak too quickly after the unit prompts you, the unit will say:

“Spoke To Soon!”

The unit will then prompt you to repeat the word.

If the word you used sounds similar to a previous word, the unit will say:

“Similar to word . . . ”

You must then start this word over, using a different word.

When your word is accepted proceed to step 2.

2. Now you will teach the unit the command words. The first four words command phone functions such as redial.

a. Press the TRAIN button. The unit will prompt:

“Say word one”

You must now say the word that you wish to use to pickup and hang up the phone (Speakerphone Word).

Command Word 1: . . .

The unit will now prompt:

“Repeat!”

You must now repeat your chosen word.

b. Press the TRAIN button. The unit will prompt:

“Say word two!”

You must now say the word that you wish to use to redial the last number used (Redial Word)

Command Word 2: . . .

The unit will now prompt:

“Repeat!”

You must now repeat your chosen word.

c. Press the TRAIN button. The unit will prompt:

“Say word Three!”

You must now say the word that you wish to use to mute the phone (Mute Word).

Command Word 3: . . .

The unit will now prompt:

“Repeat!”

You must now repeat your chosen word.

d. Press the TRAIN button. The unit will prompt:

“Say word four”

You must now say the word that you wish to use to flash the phone (Flash Word—used in call waiting to switch to the other line).

Command Word 4: . . .

The unit will now prompt:

“Repeat!”

You must now repeat your chosen word.

If the unit accepts the prompt word, it will say:

“Accepted!”

If the word is spoken differently in the two versions, the unit will say:

“Error!”

If this occurs, you will need to start over. The unit may prompt you to repeat the word again, but if the unit is silent, start over. If you speak too quickly after the unit prompts you, the unit will say:

“Spoke Too Soon!”

The unit will then prompt you to repeat the word.

If the word you used sounds similar to a previous word, the unit will say:

“Similar To Word!”

You must then start this word over, using a different word. YOU HAVE NOW PROGRAMMED THE COMMAND WORDS!

3. Next, you must program the preset dial words.

The next ten words are the commands for the dial memory buttons on the phone.

a. Press the TRAIN button. the unit will prompt:

“Say word five”

You must now say the word that you wish to use to dial the first preset on the phone.

Dial Word 5: . . .

The unit will now prompt:

“Repeat!”

You must now repeat your chosen word.

If the unit accepts the prompt word, it will say:

“Accepted!”

If the word is spoken differently in the two versions, the unit will say:

“Error!”

If this occurs, you will need to start over. The unit may prompt you to repeat the word again, but if the unit is silent, start over. If you speak too quickly after the unit prompts you, the unit will say:

“Spoke too soon!”

The unit will then prompt you to repeat the word.

If the word you used sounds similar to a previous word, the unit will say:

“Similar to word . . . ”

You must then start this word over, using a different word.

Repeat Step “A” for the Next 9 Preset Numbers

1. Party: ______ Number: ______ Word: ______

2. Party: ______ Number: ______ Word: ______

3. Party: ______ Number: ______ Word: ______

4. Party: ______ Number: ______ Word: ______

5. Party: ______ Number: ______ Word: ______

6. Party: ______ Number: ______ Word: ______

7. Party: ______ Number: ______ Word: ______

8. Party: ______ Number: ______ Word: ______

9. Party: ______ Number: ______ Word: ______

10. Party: ______ Number: ______ Word: ______

You now have successfully completed programming your unit.

II. Operating Procedure:

1. PLACE THE UNIT IN CONTINUOUS LISTENING MODE.

To put the unit into listening mode press the “Recognize” button. the “Continuous Listening Mode” light will turn on.

NOTE: If the intended user can not see the “Continuous Listening on” light which will blink on word recognition, place the sound switch in the “Speaker and Buzzer” position (downward). This will enable the user to hear when the unit recognizes the initial prompt word as well as any command or dial preset word.

2. TO PICKUP AN INCOMING CALL:

a. Clearly say the prompting word programmed in section I.,1.

PROMPT WORD: ______

b. The unit will produce a short beep if the word is recognized (AND ONLY IF THE SOUND SWITCH IS IN “SPEAKER AND BUZZER MODE”) If no beep is heard, try saying the word again after a short pause to let the unit reset.

c. After the unit beeps, pause and say the word that activates the speakerphone.

SPEAKERPHONE WORD: ______

d. You have now picked up the incoming call.

e. To hang up, follow steps 2a. through 2c.

3. TO PLACE A CALL:

f. Follow steps 2a. through 2c. to produce a dial tone.

g. Clearly say the prompting word programmed in section I., 1.

PROMPT WORD: ______

h. After the unit beeps, pause and say the word that activates the dial preset that has the number you want to dial.

1. Party: ______ Number: ______ Word: ______

2. Party: ______ Number: ______ Word: ______

3. Party: ______ Number: ______ Word: ______ 4. Party: ______ Number: ______ Word: ______

5. Party: ______ Number: ______ Word: ______

6. Party: ______ Number: ______ Word: ______

7. Party: ______ Number: ______ Word: ______

8. Party: ______ Number: ______ Word: ______

9. Party: ______ Number: ______ Word: ______

10. Party: ______ Number: ______ Word: ______

4. TO REDIAL A NUMBER:

a. Follow steps 2a. through 2c. to produce a dial tone.

b. Clearly say the prompting word programmed in section I.,1.

c. After the unit beeps, pause and say the word that activates the redial.

REDIAL WORD: ______

5. TO MUTE THE PHONE

While the phone is in operation:

a. Clearly say the prompting word programmed in section I.,1.

PROMPT WORD: ______

b. After the unit beeps, pause and say the word that activates the mute.

MUTE WORD: ______

6. TO FLASH THE PHONE:

While the phone is in operation:

a. Clearly say the prompting word programmed in section I.,1.

PROMPT WORD: ______

b. After the unit beeps, pause and say the word that activates the flash.

FLASH WORD: ______

III. Supplementary Functions

Memory Erase

1. To completely erase the memory, press the TRAIN and RECOGNIZE buttons simultaneously for 5 seconds.

2. After the buttons are released, the unit will prompt “Memory Erased”.

3. The memory is now erased, and reprogramming will require following section I in the quick start guide.

Reset

1. The unit can be reset by pressing the reset button.

2. This command clears any active function and allows the user to start over in case of an error.

Battery Backup

1. The unit comes complete with a battery backup to allow the user to operate the phone when the power goes out.

2. To conserve battery life:

a. Make sure that the unit is always plugged in when operating.

b. Make sure that the power switch is off when storing unit.

3. The battery will last approximately 24 hours during a power outage.

As can been seen from the foregoing disclosure, the present invention is a speech activated, speech operated, device for attachment to an existing landline telephone which has a one touch dialing feature, for hands-free activation and dialing. It includes: (a) a main housing, containing:

a telephone control circuit for analog input to a telephone to induce dialing of a telephone number which has been stored in a one touch dialing feature of the telephone;

an encoder circuit connected to the telephone control circuit for sending signals thereto and connected to a speech recognition module for receiving signals therefrom;

a speech recognition module connected to the encoder circuit and to a microphone and speaker for receiving speech inputs and transmitting audio information outputs, respectively, the speech recognition module having a speech recognition capability for hands free activation of the system, and having a speech recognition capability for hands free operation of the system.

It also includes: (b) a power source connection connected to at least one of the telephone control circuit, the encoder circuit and the speech recognition module for powering the device; and, (c) telephone connecting means connected to the telephone control circuit for connection to a telephone;

wherein a first user not requiring speech activated, speech operated functionality may assist in training the system by combination manual and speech operation to recognize a start word and other key words to access phone numbers stored in a landline telephone for subsequent access and for key word inputs for subsequent activation of various functions, and a second user requiring total hands free speech activated and speech operated may utilize the system touch free for both activated and operated thereof.

The preferred present invention device telephone connecting means includes speech activated connections for a plurality of one touch dialing buttons of a landline telephone having a once touch dialing feature. In some embodiments, the telephone connecting means also includes speech activated connections for a plurality of button-activated features different from one touch dialing, for voice activated initiation of said button-activated features. The present invention preferred device of further includes a training button for initiating said training instructions.

Obviously, numerous modifications and variations of the present invention are possible in light of the above teachings. It is therefore understood that within the scope of the appended claims, the invention may be practiced otherwise than as specifically described herein.

What is claimed is:

1. A speech activated, speech operated, device for attachment to an existing landline telephone which has a one touch dialing feature, for hands-free activation and dialing, which comprises:
(a) a main housing, containing:
a telephone control circuit for analog input to a telephone to induce dialing of a telephone number which has been stored in a one touch dialing feature of said telephone;
an encoder circuit connected to said telephone control circuit for sending signals thereto and connected to a speech recognition module for receiving signals therefrom;
a speech recognition module connected to said encoder circuit and to a microphone and speaker for receiving speech inputs and transmitting audio information outputs, respectively, said speech recognition module having a speech recognition capability for hands free activation of said system, and having a speech recognition capability for hands free operation of said system;
(b) a power source connection connected to at least one of said telephone control circuit, said encoder circuit and said speech recognition module for powering said device;
(c) telephone connecting means connected to said telephone control circuit for connection to a telephone;
wherein a first user not requiring speech activated, speech operated functionality may assist in training said system by combination manual and speech operation to recognize a start word and other key words to access phone numbers stored in a landline telephone for subsequent access and for key word inputs for subsequent activation of various functions, and a second user requiring total hands free speech activated and speech operated may utilize the system touch free for both activated and operated thereof.

2. The device of claim 1 wherein said speech recognition module includes both visible and audible feedback hardware and software.

3. The device of claim 1 wherein said power source connection is a plug, wire and transformer for connection to a conventional electrical outlet and for conversion of alternating current to direct current.

4. The device of claim 1 wherein said device further includes at least one battery connected to said power source connection.

5. The device of claim 1 wherein said device further includes an optional rechargeable backup battery and charger circuit.

6. The device of claim 1 wherein said telephone connecting means includes speech activated connections for a plurality of one touch dialing buttons of a landline telephone having a once touch dialing feature.

7. The device of claim 6 wherein said telephone connecting means also includes speech activated connections for a plurality of button-activated features different from one touch dialing, for voice activated initiation of said button-activated features.

8. The device of claim 6 wherein said plurality of connections includes speech activated connections for at least ten different one touch dialing buttons.

9. The device of claim 1 wherein said device further includes training instructions for a user, said training instructions including audible word outputs.

10. The device of claim 9 wherein said device further includes a training button for initiating said training instructions.

11. A hands free, speech activated, speech operated automatic dialing telephone system, which comprises:
(a) a main housing, containing:
a telephone control circuit for analog input to a telephone to induce dialing of a telephone number which has been stored in a one touch dialing feature of said telephone;
an encoder circuit connected to said telephone control circuit for sending signals thereto and connected to a speech recognition module for receiving signals therefrom;
a speech recognition module connected to said encoder circuit and to a microphone and speaker for receiving speech inputs and transmitting audio information outputs, respectively, said speech recognition module having a speech recognition capability for hands free activation of said system, and having a speech recognition capability for hands free operation of said system;
(b) a power source connection connected to at least one of said telephone control circuit, said encoder circuit and said speech recognition module for powering said device;
(c) telephone connecting means connected to said telephone control circuit for connection to a telephone; and,
(d) a landline telephone having a one touch dialing feature which is functionally connected to said telephone control circuit;
wherein a first user not requiring speech activated, speech operated functionality may assist in training said system by combination manual and speech operation to recognize a start word and other key words to access phone numbers stored in a landline telephone for subsequent access and for key word inputs for subsequent activation of various functions, and a second user requiring total hands free speech activated and speech operated may utilize the system touch free for both activated and operated thereof.

12. The device of claim 11 wherein said speech recognition module includes both visible and audible feedback hardware and software.

13. The device of claim 11 wherein said power source connection is a plug, wire and transformer for connection to a conventional electrical outlet and for conversion of alternating current to direct current.

14. The device of claim 11 wherein said device further includes at least one battery connected to said power source connection.

15. The device of claim 11 wherein said device further includes an optional rechargeable backup battery and charger circuit.

16. The device of claim 11 wherein said telephone connecting means includes speech activated connections for a plurality of one touch dialing buttons of a landline telephone having a once touch dialing feature.

17. The device of claim 16 wherein said telephone connecting means also includes speech activated connections for a plurality of button-activated features different from one touch dialing, for voice activated initiation of said button-activated features.

18. The device of claim 16 wherein said plurality of connections includes speech activated connections for at least ten different one touch dialing buttons.

19. The device of claim 11 wherein said device further includes training instructions for a user, said training instructions including audible word output.

20. The device of claim 19 wherein said device further includes a training button for initiating said training instructions.
